(19) United States
(12) Patent Application Publication
(10) Pub. No.: US 2008/0212512 A1
(43) Pub. Date: Sep. 4, 2008

(54) Method and Device for Indirect Communication Within a WiMAX Network

(76) Inventors: Ofer Harpek, Kiryat Tiyon (IL); Baniel Bronholc, Ramat A'Sharon (IL); Matty Levanda, Givat Shemuel (IL)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/381,235

(22) Filed: May 2, 2006

Related U.S. Application Data
(60) Provisional application No. 60/680,208, filed on May 12, 2005.
(60) Provisional application No. 60/681,577, filed on May 16, 2005.

(51) Int. Cl. H04B 7/14

(52) U.S. Cl. 370/315

(57) ABSTRACT

A method for indirect communication in a WiMAX network includes: determining a wireless broadband terrestrial transmission scheme by a base station; transmitting, in response to the wireless broadband terrestrial transmission scheme, a first preamble and a first data frame, by a first set of relay stations, towards multiple subscriber devices, substantially simultaneously; and transmitting, in response to the wireless broadband terrestrial transmission scheme, a second preamble and a second data frame by another relay station towards other subscriber devices. Wherein a coverage area of the other relay station does not substantially overlap a coverage area of any of the first set of relay stations.

### RELATED APPLICATIONS

This patent application claims the priority benefit of U.S. provisional patent application No. 60/680,208, entitled “Dual purpose WiMax device and method for transmitting information over terrestrial and satellite links”, filed 12 May 2005, and of U.S. provisional patent application No. 60/681,577, entitled “Method and device for indirect communication within a WiMax network”, filed 16 May 2005, each of which is incorporated herein by reference.

### FIELD OF THE INVENTION

The present invention relates to systems and methods that include multiple relay stations having substantially non-overlapping coverage areas, and that are adapted to transmit over wireless broadband terrestrial links.

### BACKGROUND OF THE INVENTION

WiMAX (World Interoperability for Microwave Access) is the name associated with a group of 802.16 IEEE standards as well as related standards such as 802.18, 802.20 AND 802.22. WiMAX allows broadband communication using terrestrial wireless links.

Part 16 of the 802.16 IEEE standard defines an air interface for fixed broadband wireless access systems. It defines complex MAC and PHY layers that allow a WiMAX transmitter to perform many modulations, and to perform multiple carrier transmissions.

In a typical WiMAX network a base station dynamically grants access to the upstream and downstream transmission links between multiple subscriber stations and the base station. The base station transmits a preamble that identifies the base station and allows the subscriber station to synchronize to the transmissions from the base station. There are multiple predefined preambles.

The quality of transmission (and reception) over the terrestrial link is usually dependent upon the exact setting of the WIMAX antenna, and may require a time consuming tuning and installation procedure. Furthermore, this quality can dynamically change, thus an initial setting of the WiMAX antenna can be less effective over time. In addition, various limitations such as having a line of sight between the base station and the subscriber stations can limit the coverage area of the base station.

Merely adding base stations is costly and can be limited by the absence of base station compatible sites. Thus, there is a need to improve the efficiency of WiMAX transmission

### SUMMARY OF THE INVENTION

A system that includes: multiple relay stations having substantially non-overlapping coverage areas, that are adapted to transmit over wireless broadband terrestrial links, multiple different preambles substantially simultaneously; and at least one other relay station adapted to transmit at least one data frame after a base station transmits at least one data frame.

A method that includes: determining a wireless broadband terrestrial transmission scheme by a base station; transmitting, in response to the wireless broadband terrestrial transmission scheme, a first preamble and a first data frame, by a first set of relay stations, towards multiple subscriber devices, substantially simultaneously; and transmitting, in response to the wireless broadband terrestrial transmission scheme, a second preamble and a second data frame by another relay station towards other subscriber devices; wherein a coverage area of the other relay station does not substantially overlap a coverage area of any of the first set of relay stations.

A method that includes: transmitting over wireless broadband terrestrial links, by multiple relay stations that are characterized by substantially non-overlapping coverage areas, multiple different preambles substantially simultaneously; and transmitting at least one data frame by at least one relay station after transmitting at least one data frame by a base station.

A system that includes: a base station adapted to determine a wireless broadband terrestrial transmission scheme; multiple relay stations adapted to transmit, in response to the wireless broadband terrestrial transmission scheme, a first preamble and a first data frame, towards multiple subscriber devices, substantially simultaneously; and another relay station adapted to transmit, in response to the wireless broadband terrestrial transmission scheme, a second preamble and a second data frame towards other subscriber devices; wherein a coverage area of the other relay station does not substantially overlap a coverage area of any of the first set of relay stations.

### BRIEF DESCRIPTION OF THE DRAWINGS

The present invention will be understood and appreciated more fully from the following detailed description taken in conjunction with the following figures:

FIG. 1 illustrates an exemplary device configured according to an embodiment of the invention;

FIG. 2 illustrates a transmission method of a subscriber station, according to an embodiment of the invention;

FIG. 3 illustrates a transmission method of a pico-base station, according to an embodiment of the invention;

FIG. 4 illustrates a transmission method of a base station, according to an embodiment of the invention

FIG. 5 illustrates a network, according to an embodiment of the invention;

FIG. 6 is a timing diagram illustrating a transmission method, according to an embodiment of the invention;

FIGS. 7 and 8 illustrate an antenna unit, according to an embodiment of the invention;

FIGS. 9-11 illustrate examples of coverage areas of a base station and multiple relay stations according to an embodiment of the invention;

FIGS. 12-18 illustrate preambles and data frames according to various embodiments of the invention;

FIGS. 19-20 are flow charts illustrating methods according to various embodiments of the invention; and

FIG. 21 illustrates a system configured according to another embodiment of the invention.

### DETAILED DESCRIPTION

The present invention is now described with reference to various figures illustrating exemplary embodiments of the invention. These illustrations are not intended to limit the scope of the invention but rather to assist in understanding same. The drawings are not to scale.

Conveniently, a system is provided. The system includes a base station and multiple subscriber stations. The base station controls traffic between the base station and the subscriber stations and at least one subscriber station is adapted to operate as a relay station. Transmission characteristics such as modulation, error correction codes, space-time coding used between a base station and a relay station differ from the transmission characteristics between the relay station and a subscriber station. In the present system, at least one relay station does not transmit a preamble.

Conveniently, the data sent from different relay stations and the base station to a subscriber station can use space-time-coding defined in the WiMAX standards. In this case each relay transmission corresponds to a row in one of the transmission format matrices originally defined in IEEE Standard 802.16 for different base station antennas. It is noted that more than one relay station can correspond to a row, that not all rows must correspond to a relay station or relay stations and that a relay station can correspond to the same row as the base station.

Conveniently, there can be some overlap between a transmission of the relay station frame and a base station frame. In this case the relay station may not be able to receive the preamble of the base station as well as additional information from the base station (such as FCH and MAP messages). The base station may send a sub-MAP message to the relay station at a certain location in the base station frame. The base station can inform the relay station about that certain location in advance, for example during an earlier base station frame. Relay stations (also referred to as pico-base stations) may also be subscriber stations, and the base station is preferably responsive to manage the traffic between the base station, relay stations and subscriber stations.

Conveniently, the base station gathers from all relay stations the timing of other preambles it receives. This enables the base station to fine time shift the frame of each relay and minimize the frame time differences of the signals received from different relays at a given area. These time differences, if small, can seem to the subscriber station as multi-path signals. Conveniently, the base station controls the traffic so as to maximize the system capacity while maintaining a requested quality of service.

A relay station can dynamically adjust its transmit radiation pattern (e.g., by selecting one or more antenna elements) to increase coverage and reduce infringement (interference) with other relay stations and other base stations. It is noted that the relay stations can have various configurations and only one is illustrated in the figures below. For example, relay stations can be implemented (without departing from the scope of the claimed invention) with or without a data link, by utilizing PHY/MAC units in one or more devices, by having one or more antennas, by including antenna elements of different shapes, by having full duplex or half duplex capability, by applying higher layer processing, and the like. It is noted that in addition to the frame structures described above, all other elements as described in the IEEE Standard 802.16 apply. For example, all permutations zones and permutation allocation to BS can now be applied to relay stations as well.

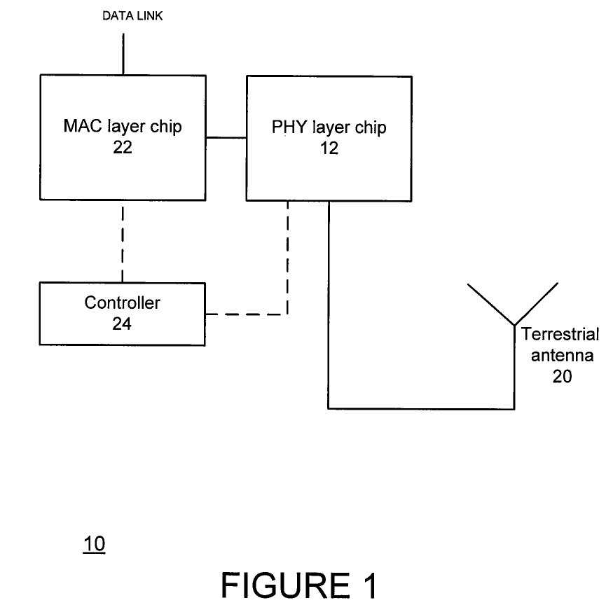

FIG. 1 illustrates a portion of a WiMAX device 10, according to an embodiment of the invention. Device 10 is conveniently a subscriber station and can transmit and receive information over terrestrial links (also referred to as transmission links). Device 10 includes a RF chip 12 that is connected to a terrestrial transmission/reception path. The terrestrial transmission/reception path includes a terrestrial antenna 20. It is noted that it can include additional (or fewer) components such as filters, amplifiers, and the like.

According to an embodiment of the invention the terrestrial antenna is used both for reception and transmission (in other cases, separate antennas may be used). Conveniently, it is a multiple sector antenna. One or more sectors can be activated simultaneously, although they can also be switched in a serial manner.

According to another embodiment of the invention the terrestrial reception/transmission path can include components that are dedicated to reception or to transmission, but this is not necessarily so. Usually it is more cost effective to use as many components and circuitry for both transmission and reception.

The RF chip 12 is connected to a MAC layer chip 22. In some cases, both chips can be integrated in a single integrated circuit. Both chips 12 and 22 are controlled by controller 24. Controller 24 controls the operation of device 10. Conveniently, the RF chip 12 receives IF signals and performs up-conversion and modulation.

The MAC layer chip 22 is connected, usually via a wired link, to multiple indoor devices such as multimedia devices, computers, game consoles and the like. MAC layer chip 22 can also be connected to a mobile device or is a part of a mobile device. The mobile device can be a cellular phone, personal data accessory, lap top and the like. The mobile device can be connected, via one or more wires, to an WiMAX antenna, and/or a WiMAX transceiver. A USB interface or any other conventional interface can be used for connecting the mobile device to the WiMAX components.

The controller 24 can also determine the parameters of the modulation and the transmission, as well as the parameters of the reception and the de-modulation. The determination can be predefined or responsive to various transmission link characteristics such as SNR, bandwidth and the like. The inventors found that the device can use modulation (and de-modulation) schemes such as OFDM, QAM64, QPSK and BPSK. It is noted that other modulations and de-modulation schemes can also be applied.

Typically, the device 10 transmits information to the base station in order to determine the quality of the transmission link and especially to select a modulation scheme. If the SNR is high then a more aggressive modulation scheme can be used, thus increasing the efficiency of transmission. On the other hand, if the SNR is low then a milder modulation scheme is used and the efficiency of the transmission is reduced. It is noted that the determination can also be responsive to additional parameters such as multi-path and the like.

Conveniently, a base station can collect channel characteristics between each BS, relay station and subscriber station in order to evaluate the reception levels and interference level associates with each transmission. In order to gain this characteristics the base station can request a relay station to measure the signal strength and deviations per-subscriber station, relay station and BS. The base station can also apply well known methods for collecting information, such as the methods illustrated in the IEEE Std802.16 which is incorporated herein by reference (e.g., RSSI mean, RSSI standard deviation, CINR mean, CINR standard deviation). Based on these measurements the base station can estimates the link budget per transmission (between base station an relay stations, between relay stations and subscriber stations and between base station and subscriber stations).

Conveniently, the base station controls all the transmissions in its coverage area (also referred to as a cell) and has the ability to estimate the link budgets accurately. Subscriber stations that are near the cell boundary and receive relays belonging to other BS or other BS at a level comparable to the level they receive their relays and BS has higher level of link budget uncertainty since the BS cannot get the needed information directly. Communication between the BS can reduce this uncertainty.

The controller 24 can participate in a tuning sequence during which the device 10 can determine whether to transmit directly to the base station (BS) or to transmit to another subscriber station that will convey the transmissions of device 10 to the base station. The other subscriber station is referred to as a pico base station (PBS). The pico base station can act as a relay station thus it is also referred to as a relay station. According to an embodiment of the invention device 10 can also act as a PBS, but this is not necessarily so.

According to an embodiment of the invention device 10 first checks the quality of the transmission link to the base station and only of the quality of the transmission link is lower than a predefined quality threshold then device 10 starts to checks whether it can transmit to a PBS. This is not necessarily so and a tuning sequence can initiate in any case or in response to other criteria. The selection between the base station and one or more PBS can be responsive to the quality of transmission link. Conveniently the selection is also responsive to the load imposed upon the PBS. For example, if a first PBS already serves multiple subscriber stations and another PBS serves only one other subscriber station then device 10 will probably select the second PBS. According to various embodiments of the invention this tuning sequence can be executed in a periodical manner, in a semi-random manner, in a random manner, and additionally or alternatively in response to an event such as a reduction in the quality of the transmission link.

It is further noted that the quality of the selected transmission link can affect the frequency of the tuning sequences. For example, lower quality will lead to more frequency tuning sequences. According to an embodiment of the invention, the tuning sequence is also responsive to previous tuning sequences and to success or failures of previously established links. It is noted that the tuning sequences and the selection between base station and PBS can also responsive to the time of day, seasons, ambient temperature, humidity and the like. It is further noted that the subscriber station can monitor the results of tuning sequences and provide tuning statistics that can aid the selection between transmission links.

According to yet a further embodiment of the invention the length and/or frequency of the tuning sequences is responsive to the load imposed on the network. For example, less loaded networks can allow more frequent tuning sequences without hampering their performance. Conveniently, the tuning sequence also allows a base station with a multiple sector WiMAX antenna to select which sector or sectors to use, and during which periods. A PBS can use one sector to exchange information with the BS, another sector in order to exchange information with a first subscriber station and yet another sector to exchange information with a second subscriber station.

According to an embodiment of the invention the suggested method and device allow to expand the coverage area of a base station and improve the transmission quality within the network. Conveniently, the tuning sequence is performed automatically (e.g., without human input) and allows a subscriber station to adjust to the transmission link characteristics, and by selectively using a multiple sector antenna the installation procedure can be simple, as the fine tuning will be done by the subscriber station itself.

It is noted that the device 10 can also be a pico-base station but its controller 24 would need to be adapted to perform pico-base station tasks, such as sequence 200 of F3. Those of ordinary skill in the art will appreciate that the subscriber stations, the pico-base station and the base station can operate in various modes such as Time Division Duplex and Frequency Division Duplex and can operate as a half duplex or full duplex devices. For simplicity of explanation it is assumed that they operated in a TDD mode. It is also noted that although it is assumed that the same pico-base station is selected for both transmitting information to a certain subscriber station and for receiving information from that subscriber station this is not necessarily so, especially when the subscriber station uses FDD.

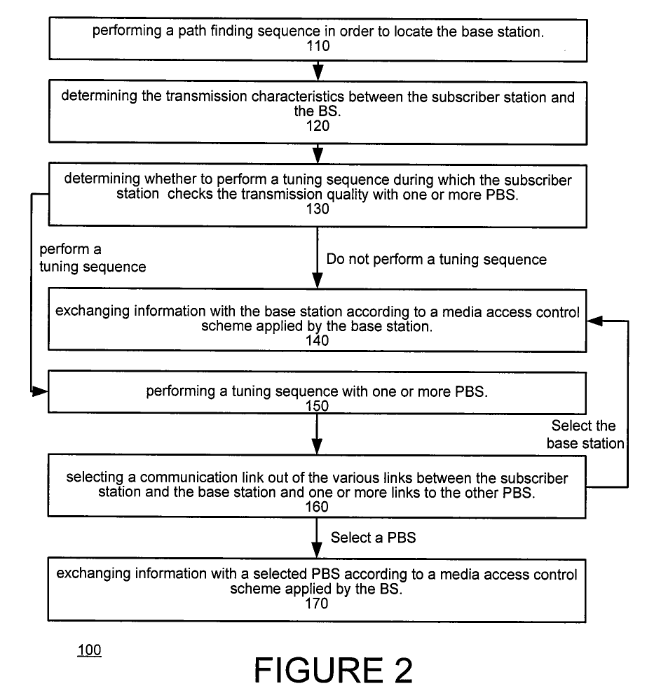

FIG. 2 illustrates an initialization sequence 100 of a subscriber station, according to an embodiment of the invention. Sequence 100 starts by stage 110 of performing a path finding sequence in order to locate the base station. Stage 110 is followed by stage 120 of determining the transmission characteristics between the subscriber station and the BS. This stage may include transmitting various signals that are modulated in different modulation schemes and determining which signal was received properly. It is noted that during stage 120 the subscriber station receives from the base station media access grants, in order to transmit information towards the BS. These grants can be in various formats, including a MAP message that allocated upstream timeslots to subscriber stations.

Stage 120 is followed by stage 130 of determining whether to perform a tuning sequence during which the subscriber station will check the quality of transmission links between the subscriber station and one or more PBS. For example, if a QAM64 modulation scheme can be used between the subscriber station and the base station then a tuning sequence is not required. If the answer is negative (no need to perform such a tuning sequence) then stage 130 is followed by stage 140 of exchanging information with the base station according to a media access control scheme determined by (or applied by) the base station. If the answer is positive (there is a need to perform a tuning sequence) then stage 130 is followed by stage 150 of performing a tuning sequence with one or more PBS.

Stage 150 is followed by stage 160 of selecting a transmission link out of the various links between the subscriber station and the base station and one or more transmission links between the subscriber station and one or more pico-base stations. The selection can be responsive to the quality of the transmission link, the load of each pico-base station and the like.

If the selected transmission link is the link between the subscriber station and the base station then stage 160 is followed by stage 150. Else, stage 160 is followed by stage 170 of exchanging information with a selected pico-base station according to a media access control scheme applied by the base station. It is noted that stage 170 and stage 140 can be followed by stage 120, such as to allow dynamic selection of the transmission link. According to another embodiment of the invention the stages 120 and 150 can include selecting which antenna sector (or sectors) to activate during a transmission or reception sequence.

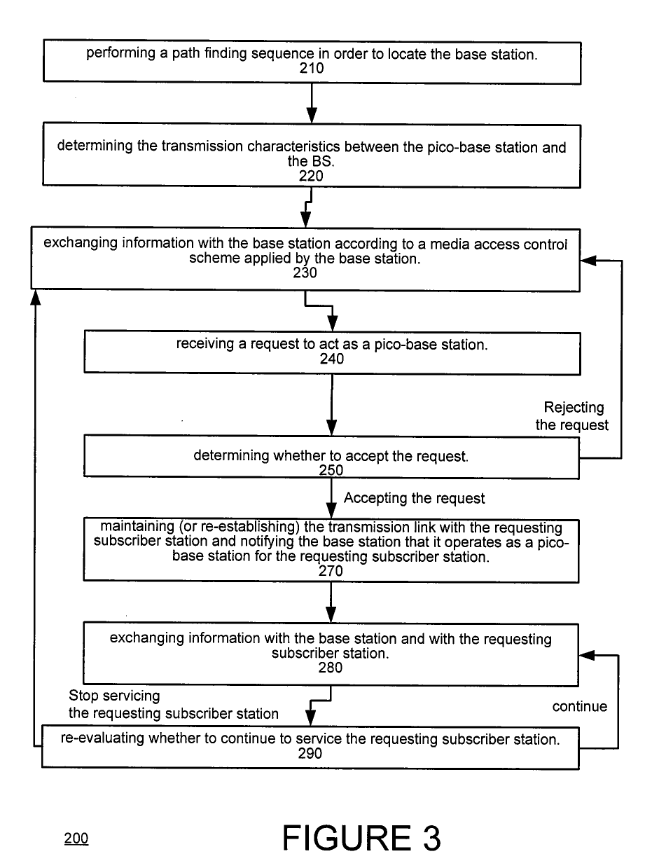

FIG. 3 illustrates a transmission sequence 200 of a pico-base station, according to an embodiment of the invention. For convenience of explanation a subscriber station that utilized a pico-base station is referred to as a requesting subscriber station. For simplicity of explanation it is assumed that only one requesting subscriber station is serviced, thus when the pico-base station declines to service (or stops the service) the requesting subscriber station then it continues to (or starts to) operate as a subscriber station. This is not necessarily so, especially if the pico-base station services multiple requesting subscriber stations.

It is noted that a pico-base station can start operating by performing various stages of method 100, and can also operate as a subscriber station until accepting a request to serve as a pico-base station. For simplicity of explanation the unique stages of a pico-base station are illustrated herein.

Sequence 200 starts by stage 210 of performing a path finding sequence in order to locate the base station. Stage 210 is followed by stage 220 of determining the transmission characteristics between the pico-base station and the BS. Stage 220 is followed by stage 230 of exchanging information with the base station according to a media access control scheme applied by the base station.

Stage 230 is followed by stage 240 of receiving a request to act as a pico-base station. It is noted that the request can be preceded by a stage of selecting the pico-base station by the requesting subscriber station. The selection (made by the requesting subscriber station) includes establishing a link with the requesting subscriber station and determining the quality of the transmission link. It is further noted that the pico-base station can decline to participate in the selection process.

Stage 240 is followed by stage 250 of determining whether to accept the request. The pico-base station can determine not to accept the request for various reasons, including low quality transmission link with the base station or a low quality transmission link with the requesting subscriber station, high load and the like. If the determination is negative stage 250 is followed by stage 230. The requesting subscriber station will receive an indication that his request was not granted.

If the answer is positive then stage 250 is followed by stage 270 of maintaining (or re-establishing) the transmission link with the requesting subscriber station and notifying the base station that it operates as a pico-base station for the requesting subscriber station.

Stage 270 is followed by stage 280 of exchanging information with the base station and with the requesting subscriber station. The pico-base station will convey the media access requests of the requesting subscriber station to the base station, while conveniently tagging them as requests of the requesting subscriber station, and convey to the requesting subscriber station the grants issued by the base station. It is noted that the signaling can be done in various manners, such as sending control information or signals, using different transmission frequency for transmissions of the requesting subscriber station and the like. It is noted that the pico-base station can maintain a routing table that includes the requesting subscriber stations that it services, and send the table to the base station.

Stage 280 can be followed by stage 290 that includes reevaluating whether to continue to service the requesting subscriber station. Stage 290 can be followed by stage 280 or by stage 230, if the pico-base station decided to stop servicing the requesting subscriber station. If the pico-base station decide to stop servicing the requesting subscriber station it notifies the requesting subscriber station and the base station. It is further noted that the requesting subscriber station can also determine to stop using the pico-base station, and notify the pico-base station accordingly. If the amount of serviced requesting subscriber station changes the pico-base station notifies at least the remaining requesting subscriber stations and the base station.

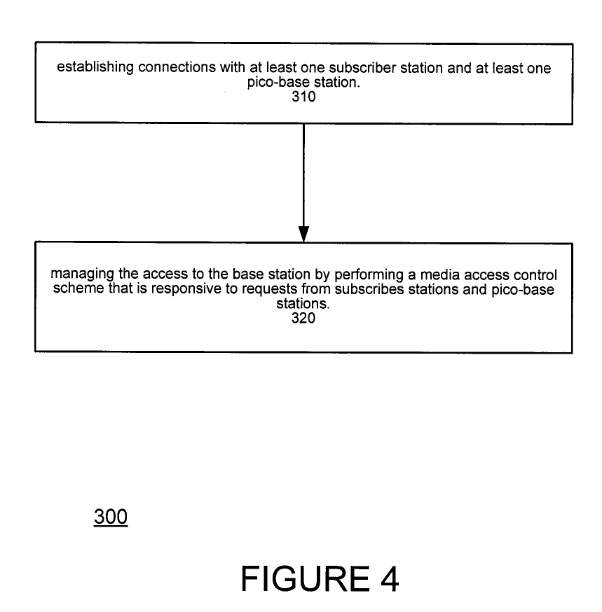

FIG. 4 illustrates a transmission sequence 300 of a base station, according to an embodiment of the invention. Sequence 300 starts by stage 310 establishing connections with at least one subscriber station and at least one pico-base station. It is noted that stage 310 may include establishing a connection with a subscriber station that later on becomes a pico-base station. A pico-base station can return to be a subscriber station when it stops to service other subscriber stations. Stage 310 may include receiving, from each pico-base station the list of subscriber stations they service. This list can be in a format of a routing table, but this is not necessarily so.

Stage 310 is followed by stage 320 of managing the access to the base station by performing a media access control scheme that is responsive to requests from subscribes stations and from pico-base stations. Stage 320 may include separating between requests that originate from a pico-base station and requests that originate from a subscriber station but is provided to the base station via a pico-base station. Conveniently, stage 320 includes receiving updates from the pico-base stations about the subscriber stations they service. This update can be generated in periodical manner, in response to events, in response to transmission parameters, in a random manner, in a semi-random manner, or in a combination of the above.

According to an embodiment of the invention a pico-base station can also service another pico-base station. Thus, a subscriber station can convey information to the base station via two or more pico-base stations.

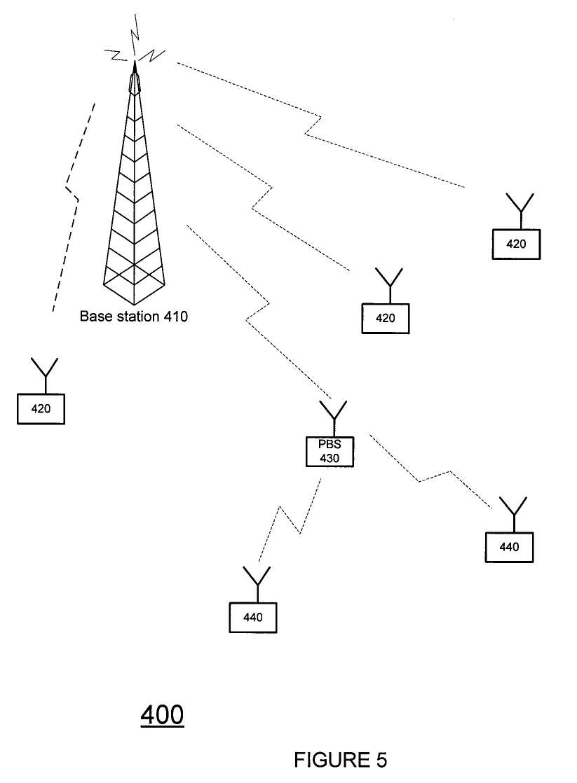

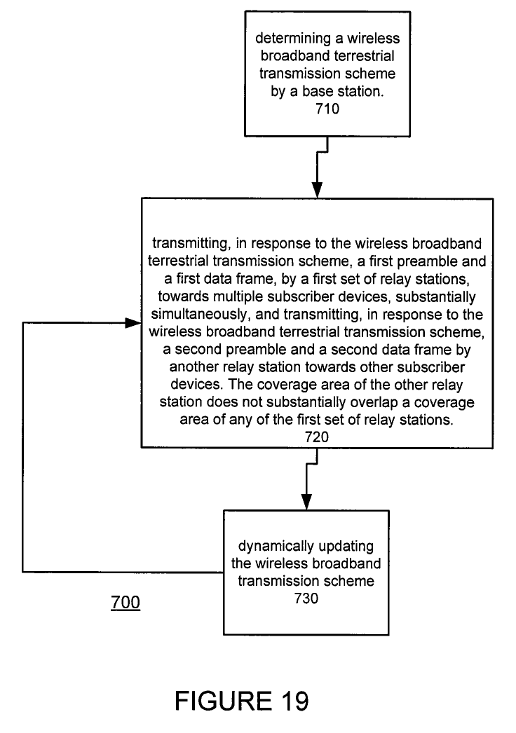

FIG. 5 illustrates a network 400, according to an embodiment of the invention. Network 400 includes a base station 410, multiple subscriber stations 420 that exchange information with the base station 410, a pico-base station 430 and multiple subscriber stations 440 that exchange information with the base station 410 via the pico-base station. It is noted that such a network can include multiple pico-base stations and multiple base stations. FIG. 19 illustrates a system in which these is a certain overlap between the coverage areas of a base station and a relay station.

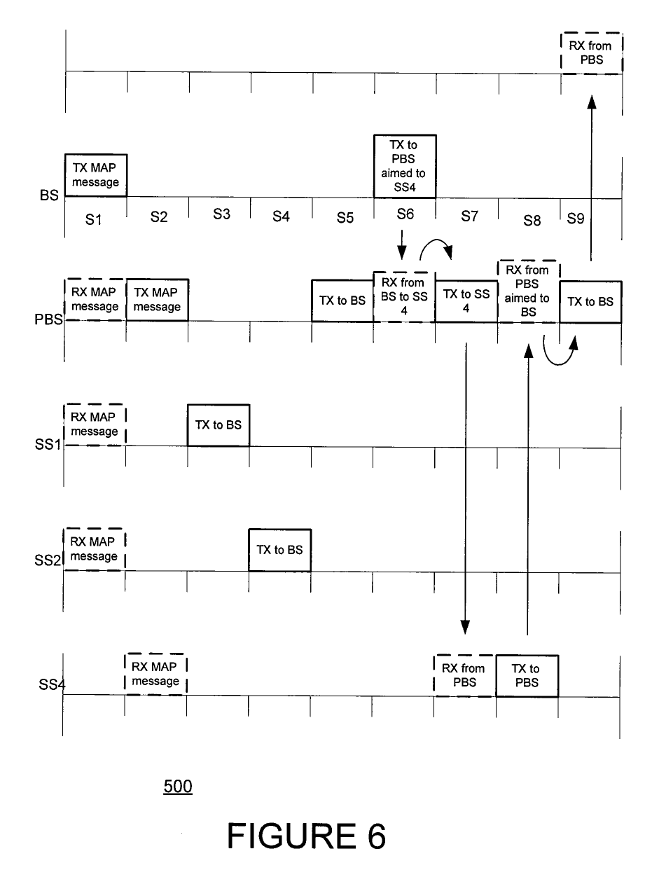

FIG. 6 is a timing diagram 500 illustrating a transmission sequence, according to an embodiment of the invention. It is noted that the base station, pico-base station and the subscriber stations use TDD, thus a certain element can receive information at one timeslot and transmit information at another timeslot. It is noted that these elements can also use FDD thus allowing simultaneous transmission and reception. A transmission of information is represented by continuous boxes that includes the text “TX”. A reception of information is represented by dashed-line boxes that include the text “RX”.

At a first timeslot S1 the base station (BS) transmits a MAP message that allocates access to the uplink and downlink terrestrial links during timeslots S3-S9. It is noted that the BS can allocate access to the upstream and downstream links in other manners. The MAP message allows the pico-base station (PBS) to re-transmit the MAP message during a second timeslot S2, allows a first subscriber station SS1 to transmit information to BS during a third timeslot S3, allows a second subscriber station SS2 to transmit information to BS during a forth timeslot S4, allows PBS to transmit information to BS during a fifth timeslot S5, allows PBS to receive information from BS (to be sent to a serviced subscriber station SS4) during a sixth timeslot S6, allows PBS to transmit the received information to SS4 during a seventh timeslot S7, allows SS4 to transmit information (to be sent to BS) to PBS during an eighth timeslot S8, allows PBS to transmit the received information from SS4 to BS during a ninth timeslot S9.

It is noted that the serviced subscriber station SS4 receives the MAP message and expects to receive information during the seventh timeslot S7 and to transmit information to the PBS during the eighth timeslot S8. It is further noted that during the second timeslot S2 the PBS retransmits the MAP message to make sure that SS4 receives the MAP message. During S2-S9 the various subscriber stations, the PBS and the BS transmit or receive according to the MAP message.

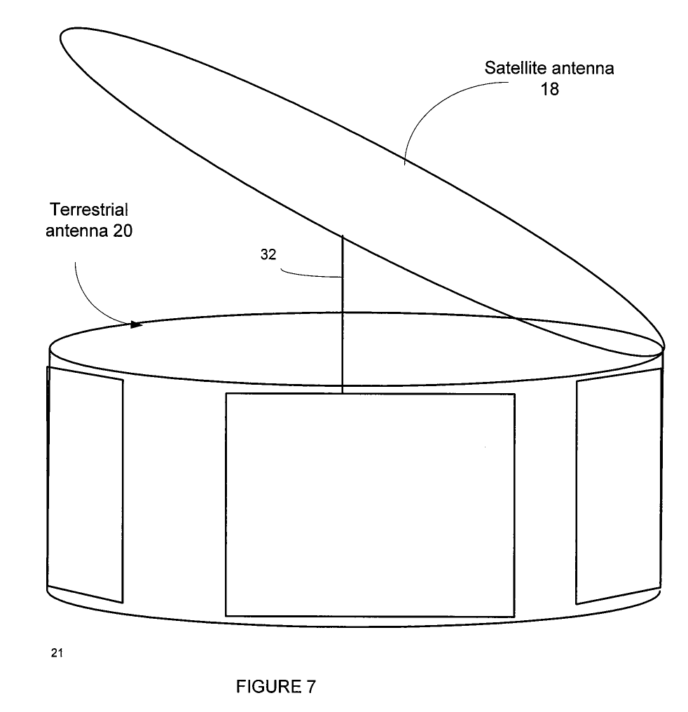

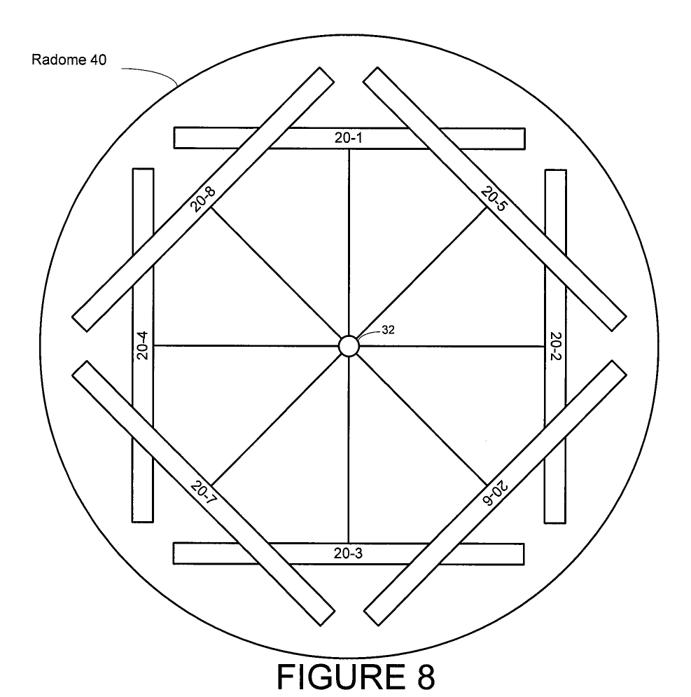

The following figures illustrate an antenna unit. It is noted that other terrestrial antennas can be used, and that the satellite antenna is optional. FIG. 7 illustrates a terrestrial antenna 20 and a satellite antenna 18, according to an embodiment of the invention. FIG. 8 illustrates a cross sectional view of an antenna unit 21. It is noted that according to another embodiment of the invention the antenna unit can only have a terrestrial antenna and does not include a satellite antenna.

The satellite antenna 18 conveniently points towards the corresponding Geostationary satellite through manual, mechanical, or electrical steering, and using either open loop, or closed loop adjustment. The inventors use a fixed satellite antenna oriented at an angle of 40 degrees such as to receive transmissions from a satellite beam that spans between 23.3 and 59.9 degrees. The terrestrial antenna 18 is conveniently a WiMAX multi sector antenna.

Conveniently, satellite antenna 18 is adapted to receive right hand circularly polarized radiation and left hand circularly polarized radiation over a satellite link. Satellite antenna 18 is oriented in relation to an imaginary vertical axis that is substantially parallel to multiple elements of the terrestrial multiple sector antenna. The satellite antenna 18 is connected to a structural element 30 that includes a central rod 32 as well as multiple horizontal rods 34 that connect the central rod 32 to each of the elements 20-I of the terrestrial multiple sector antenna 20. The central rod 32 can be pivotally mounted to base element (not shown).

FIG. 7 illustrates a four element antenna while FIG. 8 illustrates an eight element antenna. It is noted that the number of elements can vary, as well as their relative angular position in relation to each other. The inventors used a terrestrial antenna 20 that had eight antenna elements. Four antenna elements were oriented at 0, 90, 180 and 270 degrees, while four antennal elements were oriented at 45, 135, 215 and 305 degrees.

It is noted that the number of antenna elements, the shape of each antenna element, the angular range covered by each antenna element as well as the relative position of the antenna elements in relation to each other can differ from those illustrated in FIGS. 7 and 8. For example, a terrestrial antenna can include four antennal elements with 90 degrees between them on one level, and another four element antennas positioned on another level, wherein the four other antenna elements are oriented by 45 degrees in relation to the first four antennas.

The beam forming can be such that each element is used solely for transmission/reception to one of the eight directions. The beam forming can be such that two or more elements are combined in phase to produce a radiation pattern to each of the eight directions. Thus, in order to create a radiation pattern to a selected direction, two or more elements will be used, combined together in phase. To create a radiation pattern to another selected directions, a combination of other two or more elements will be used. The terrestrial antenna is also supporting omni directional beam, by combining all the terrestrial antenna elements together.

Conveniently, the satellite antenna 18, the terrestrial antenna 20 are surrounded (or at least partially surrounded) by radome 40. Conveniently, the radome 40 is fixed to the structural element (not shown), so that when the radome 40 rotates the structural element (as well as antennas 18 and 20) rotate. The structural element and/or radome 40 can be pivotally connected to a base element (not shown). The base element can be fixed to a rooftop or another stationary element.

According to an embodiment of the invention location information is printed on an external surface of the radome 40. Different location information can be printed on different positions (that correspond to different angles in relation to an imaginary center of the radome) of radome 40, thus allowing to direct the antaean unit 21 towards a required direction (that corresponds to a location of the satellite) by rotating the radome until a location indication printed on radome 40 is directed towards a predefined direction (that can be determined by using, for example, a compass).

The location information can include the name of cities, states, countries and the like (longitude, altitude). The location information printed on a radome sold in New York can differ from the location information printed on a radome sold in Los Angeles, but this is not necessarily so. According to another embodiment of the invention the same location information can be used in different locations.

The antenna unit 21 defines multiple reception (an/or transmission) paths. Satellite antenna 20 can receive both right hand circularly polarized radiation and left hand circularly polarized radiation thus can define two radiation paths. Each antenna element (sector) 20-I of terrestrial antenna 20 can define its own reception paths. It is noted that the radiation received by two or more antenna elements 20-I can be combined prior to being received by other elements (such as a receiver front end) or system 10. It is further notes that satellite antenna 18 as well as terrestrial antenna 20 can be used for transmitting information. Multiple antenna elements 20-I of terrestrial antenna 20 can transmit the same information.

The satellite antenna as well as the elements 20-I of the terrestrial antenna 20 can be connected via an interfacing unit (that may include switches, combiners, splitters and the like) to a receiver front end and to a transmitter front end. Radiation can be transmitted by one or more antenna element (or satellite antenna). Additionally or alternatively, radiation can be received by one or more antenna element and sent to a receiver.

According to various embodiments of the invention the base station determines the configuration of the pico base stations, and especially the area covered by a certain pico base station. For example, a base station can request (by sending control information) a certain pico-base station to use its first antenna element (20-1) to transmit information (thus covering a certain area) and request from another pico-base station to use one or more antenna elements.

The base station can also determine the transmission mode of the different pico base stations. Conveniently, if the coverage area of two or more pico base station overlap then the base station can determine that these pico base station either transmit the same data (what is referred to as diversity mode) or transit different data but apply time division multiplexing and/or frequency division multiplexing.

The base station can alter the transmission mode according to a predefined transmission scheme, in response to events or in combination thereof. The transmission scheme can be responsive to currently active pico base stations, to current interference level, to signal to noise ratios, to information load, to the locations of active pico base stations, to the location of active subscriber stations, and the like.

For example, if a certain pico base station is required to transmit information through multiple antennal elements concurrently this reduces the power of transmission and accordingly reduces the signal to noise ration as well as reducing the coverage area of that pico base station. Yet for another example, if a certain pico base station is not currently active (for example, the owner of the device that acts as a pico base station powers down the receiver) then other pico base station should be found in order to cover the area that should have been covered by that pico base station. Yet for a further example, if the beams of two pico base stations overlap they may be required to relay the same data.

The base station can manage the usage of uplink and downlink resources, but this is not necessarily so. For example, the pico base stations can operate in a tunneling mode in which they are not aware of the content of control and information sent to the subscriber devices. This concept can be applied by using simple and relatively cheap pico base stations. Thus subscriber stations can be activated as pico base stations. In tunneling mode the control information and/or headers of frames aimed to subscriber stations are viewed as a part of the payload of the relay station traffic. Yet for another example, the base station as one or more pico base station can participate in the management of uplink traffic.

According to an embodiment of the invention a base station and each relay station can transmit a preamble that enables receiving subscribes station to synchronize to their transmissions. Relay stations that are mutually independent transmit different preambles. A base station can instruct a subscriber station to synchronize to a certain preamble.

The base station can instruct a relay station to transmit a certain preamble by providing preamble information that allows the relay station to select which out of a group of predefined preambles to transmit. In a typical WiMax station a base station transmits a preamble that identifies the base station and allows the subscriber station to synchronize to the transmissions from the base station. There are multiple predefined preambles. According to an embodiment of the invention a preamble is transmitted by a base station and is not re-transmitted by a relay station.

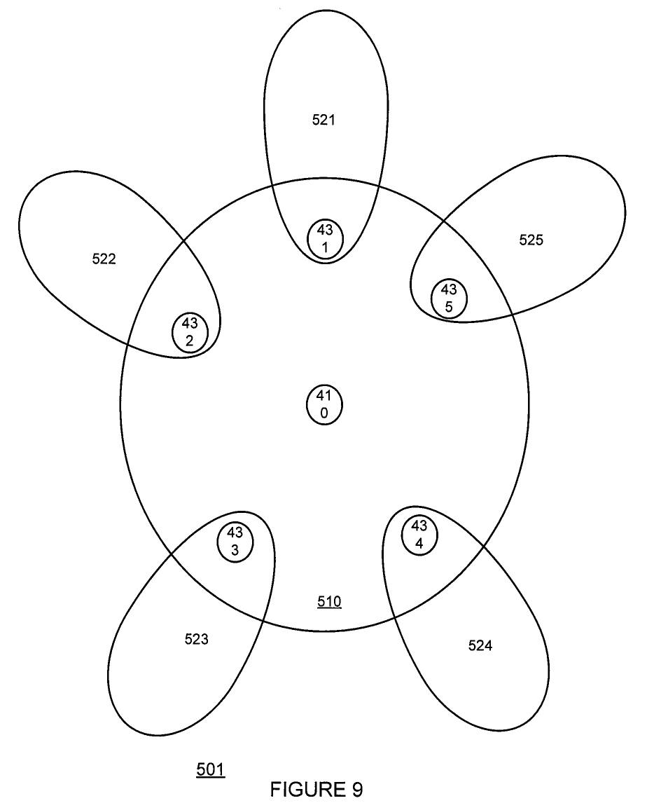

FIGS. 9-11 illustrate coverage areas of a base station and multiple pico base stations according to various embodiment of the invention. In FIG. 9 a base station 410 coverage area 510 is substantially circular. Within this coverage area there are five pico base stations 431-435, each including a multiple sector terrestrial antenna such as terrestrial antenna 20 of pervious figures. Each pico base station can transmit during one or more of multiple antennal elements. The base station can control which antenna element will be used for transmission at any given moment.

It is noted that coverage areas 521-525 of relay stations 431-435 do not overlap and that each of these relay station also has another coverage area for transmitting uplink transmissions towards the base station. For simplicity of explanation the additional coverage area is not shown.

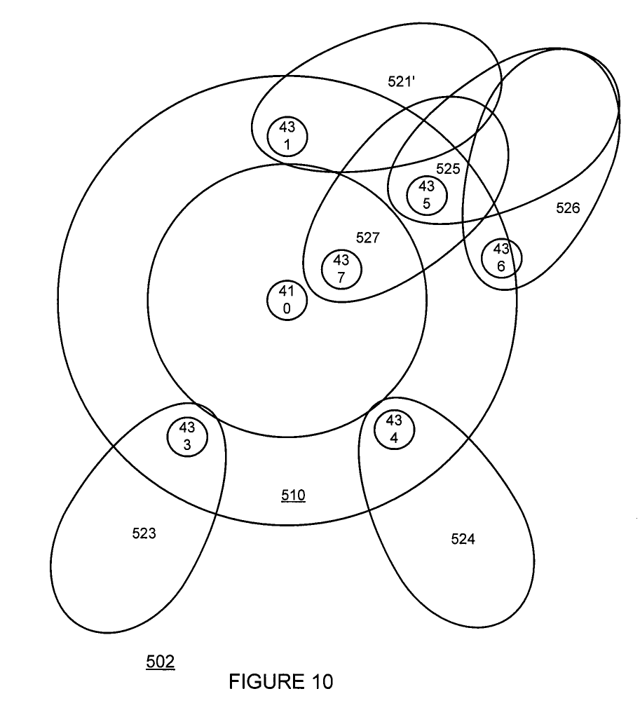

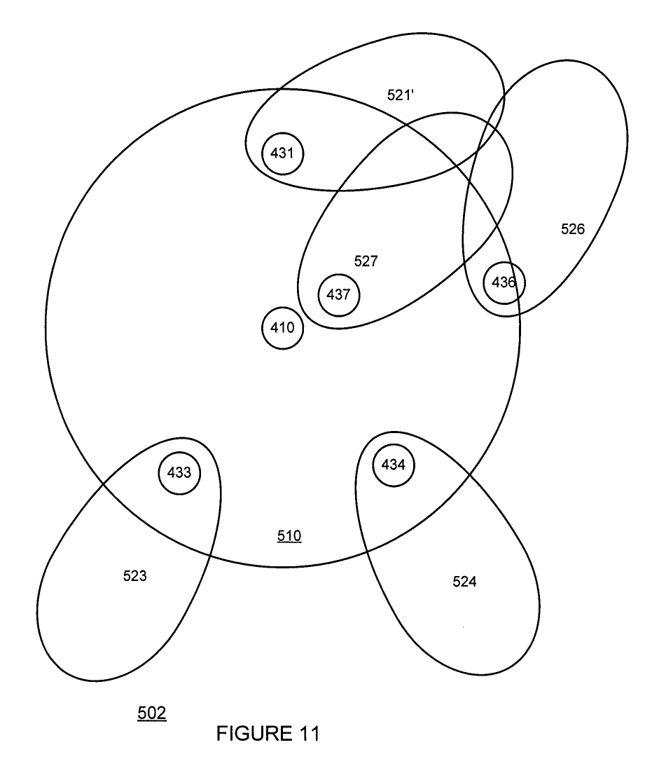

FIG. 10 illustrates seven relay stations 431-437 that have seven coverage areas 521′ and 522-527. Coverage areas 525, 526, 527 and 521′ partially overlap. Coverage areas 521′, 526 and 527 are designed such as to cover coverage area 525. Thus, if relay station 435 is not active (as illustrated in FIG. 11), relay stations 431, 436 and 437 can still transmit data and preambles to subscriber stations positioned within coverage area 525. In this scenario the different relay stations (431, 435, 436 and 437) transmit (towards coverage area 525) the same data frames and the same preambles.

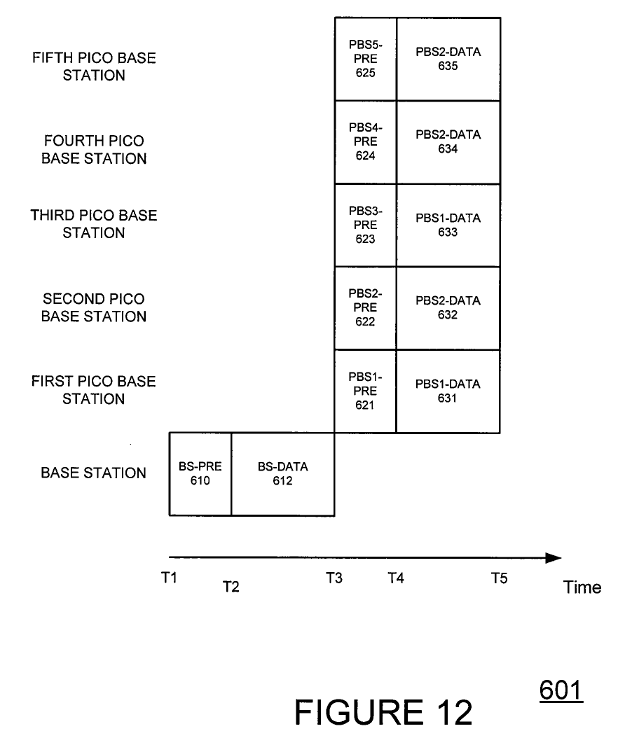

FIGS. 12-18 illustrate preambles and data frames according to various embodiment of the invention. FIG. 12 illustrates a transmission of a base station preamble (BS-PRE 610) that is followed by a transmission of a base station data frame (BS-DATA 612), by a transmission (substantially in parallel) of five different preambles (PBS1-PRE-PBS5-PRE 621-625) by five different relay stations and finally a transmission of (substantially in parallel) of five different data frames (PBS1-DATA-PBS5-DATA 631-635) by five different relay stations. This transmission scheme can correspond to FIG. 9.

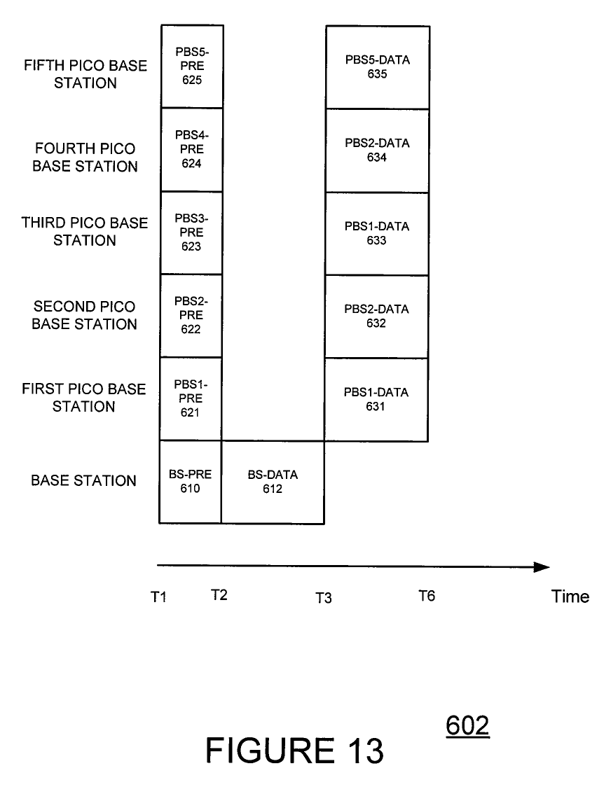

FIG. 13 illustrates a transmission of a six preambles substantially in parallel—a transmission of base station preamble (BS-PRE 610) as well as a transmission of five different preambles (PBS1-PRE-PBS5-PRE 621-625) by five different relay stations. These preambles are followed by a transmission of a base station data frame (BS-DATA 612), that in turn is followed by a transmission (substantially in parallel) of five different data frames (PBS1-DATA-PBS5-DATA 631-635) by five different relay stations.

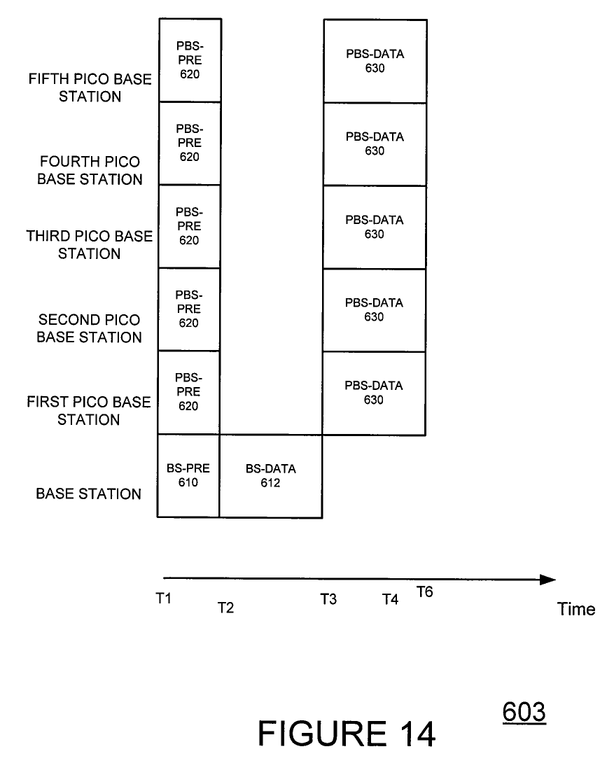

FIG. 14 illustrates a transmission of a base station preamble (BS-PRE 610) as well as a transmission of another preamble (PBS-PRE 620) by five different relay stations. Each relay station transmits the same preamble. This transmission is followed by a transmission of a base station data frame (BS-DATA 612), that in turn is followed by a transmission (substantially in parallel) of another data frame (PBS-DATA 630) by five different relay stations. Each relay station transmits the same data frame.

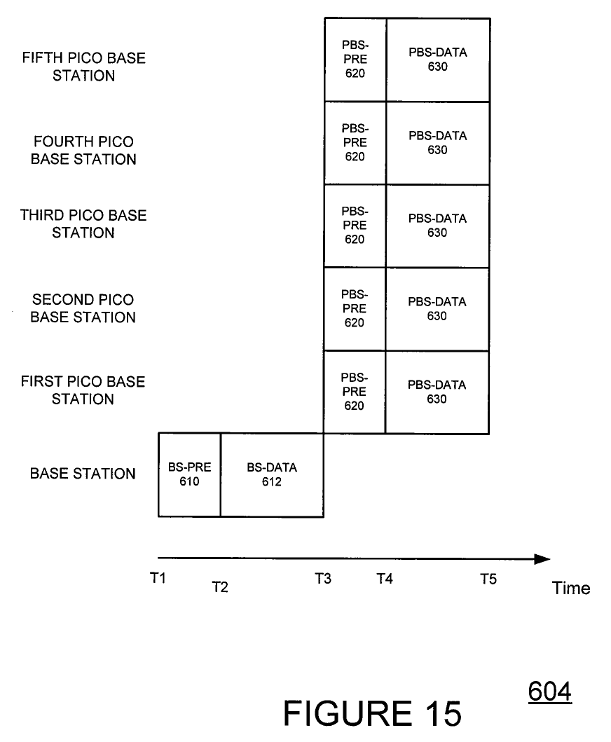

FIG. 15 illustrates a transmission of a base station preamble (BS-PRE 610) that is followed by a transmission of a base station data frame (BS-DATA 612), by a transmission (substantially in parallel) of another preamble (PBS-PRE 620) by five different relay stations and finally a transmission of (substantially in parallel) of another data frame (PBS-DATA 630) by five different relay stations.

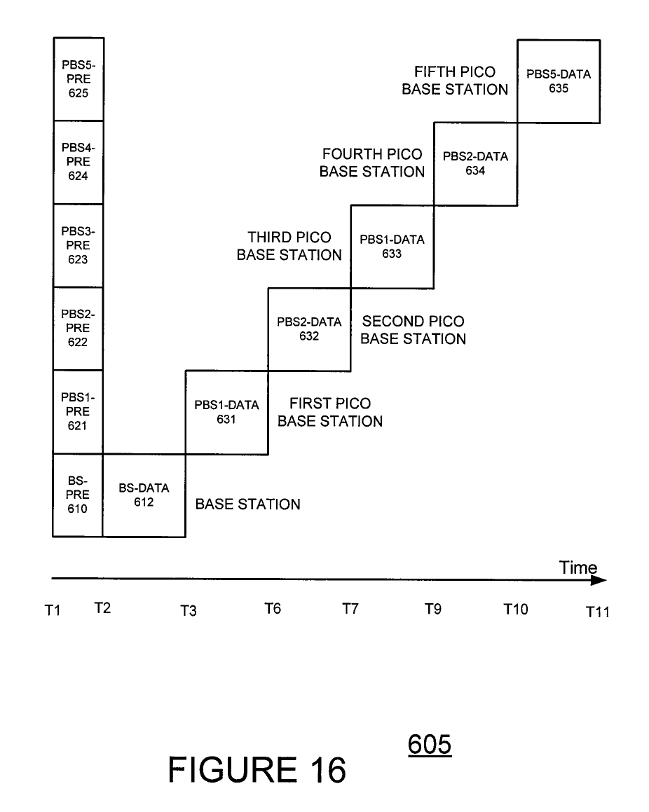

FIG. 16 illustrates a transmission of a six preambles substantially in parallel—a transmission of base station preamble (BS-PRE 610) as well as a transmission of five different preambles (PBS1-PRE-PBS5-PRE 621-625) by five different relay stations. These preambles are followed by a serial transmission of data frames, starting from a base data frame (BS-DATA 612) and then the five different data frames (PBS1-DATA-PS5-DATA 631-635).

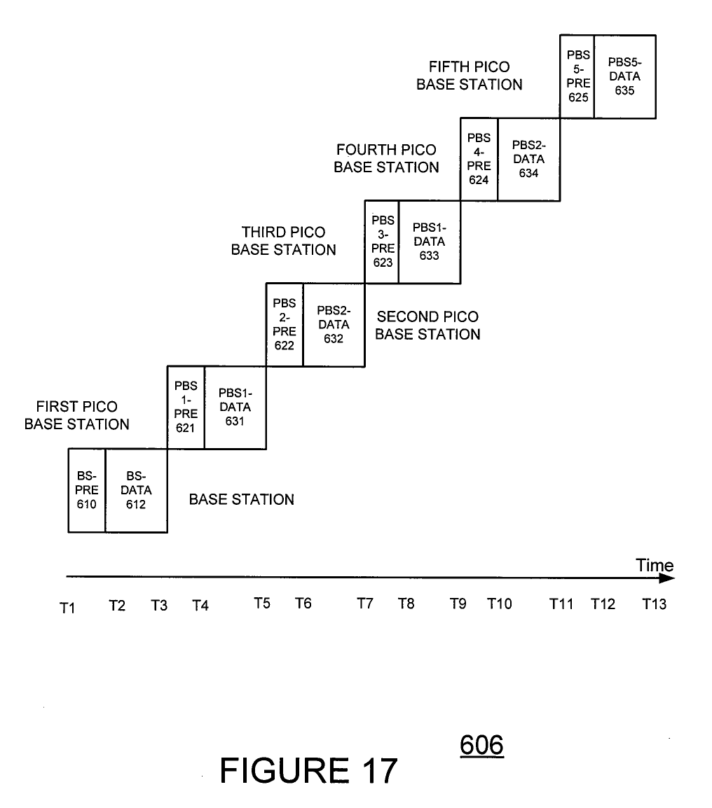

FIG. 17 illustrates a sequential transmission a pairs of preambles and data frames.

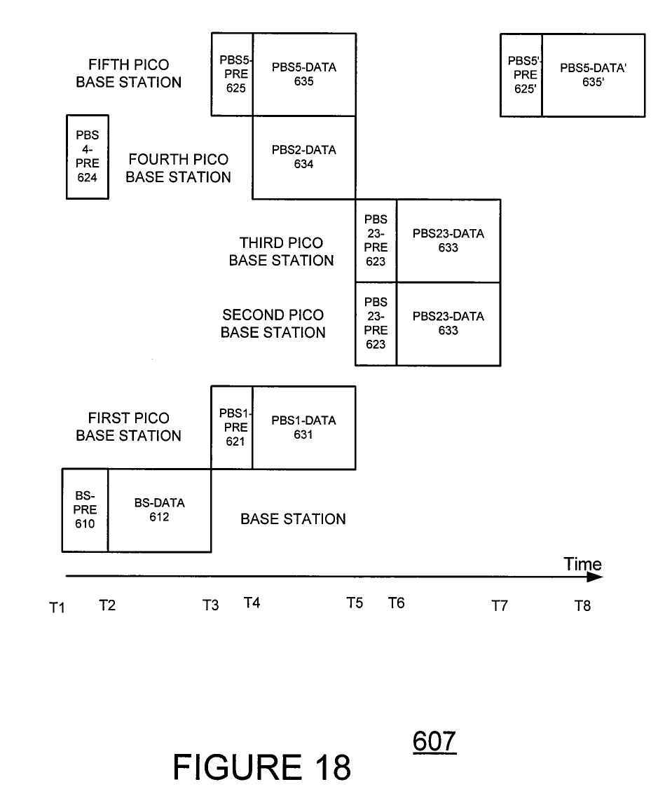

FIG. 18 illustrates a mixture of transmission modes. During a first period (extending between T1 and T3) a base preamble as well as a fourth relay station preamble are transmitted and then a base data frame is transmitted. During a second period (extending between T3 and T5) two different relay station preambles are transmitted (of the first and fifth relay stations) substantially in parallel. These transmissions are followed by a transmission of three different relay data frames (of the fifth, fourth and first relay stations). During a third period (extending between T5 and T7) the third and second relay stations transmit the same preamble (PBS23-PRE 523) and also transmit the same data frame (PBS23-DATA 633). During a fourth period only the fifth relay station transmits. It is noted that other transmission mode combinations can be used and that the base station can dynamically determine which transmission mode to apply as well as which relay station shall transmit.

FIG. 19 illustrates method 700 according to an embodiment of the invention. Method 700 starts by stage 710 of determining a wireless broadband terrestrial transmission scheme by a base station. Conveniently, this scheme aims to maximize the traffic that passes through the network. Accordingly, a subscriber station can be instructed to receive information from a certain relay station (identified by a preamble) and not necessarily by the base station or the source of the strongest signal received by that subscriber station.

Stage 710 is followed by stage 720 of transmitting, in response to the wireless broadband terrestrial transmission scheme, a first preamble and a first data frame, by a first set of relay stations, towards multiple subscriber devices, substantially simultaneously, and transmitting, in response to the wireless broadband terrestrial transmission scheme, a second preamble and a second data frame by another relay station towards other subscriber devices. The coverage area of the other relay station does not substantially overlap a coverage area of any of the first set of relay stations.

Conveniently, a coverage area of a first relay station of the first set of relay stations overlaps a coverage area of a second relay station of the first set of relay stations. It is noted that a coverage area indicates a coverage area that is currently being used. Thus, if a multiple sector terrestrial antenna currently uses one of its antenna elements to transmit than the coverage area of that one antenna element is regarded as the current coverage area of the antenna. Conveniently the second preamble differs from the first preamble.

Conveniently stage 720 is followed by stage 730 of dynamically updating the wireless broadband transmission scheme and jumping to stage 720. As mentioned above the updating can be made according to a predefined scheme, in response to events or in combination thereof. The wireless broadband terrestrial transmission scheme can be responsive to currently relay stations, to current interference level, to signal to noise ratios, to information load, to the locations of active relay stations, to the location of active subscriber stations, and the like.

Conveniently, stage 710 is responsive to a state of relay stations and potential relay stations. For example, if a certain relay station is not active other relay stations should be used. Yet for another example, if certain subscriber stations are activates they may need to be services by one or more relay station or by the base station itself. Conveniently stage 710 of determining is responsive to at least one characteristic of terrestrial links established between the base station and multiple relay stations.

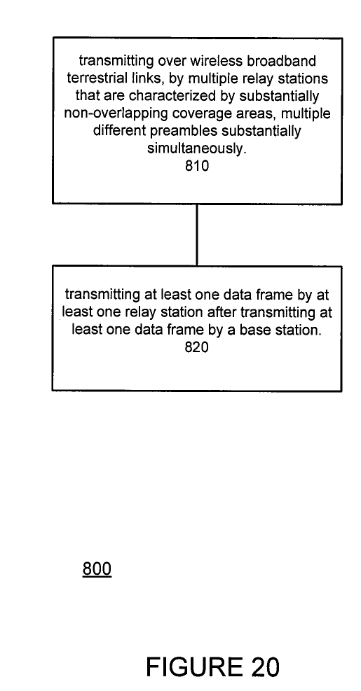

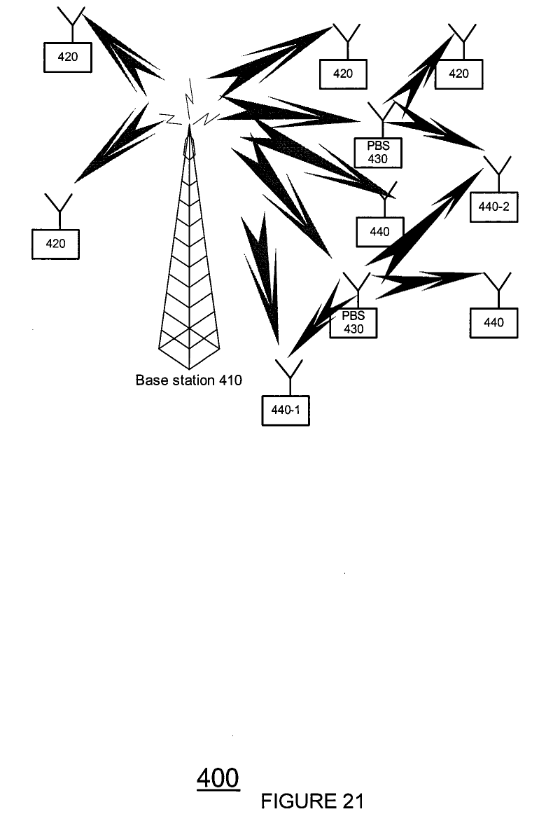

FIG. 20 illustrates method 800 according to an embodiment of the invention. Method 800 starts by stage 810 of transmitting over wireless broadband terrestrial links, by multiple relay stations that are characterized by substantially non-overlapping coverage areas, multiple different preambles substantially simultaneously. Stage 810 is followed by stage 820 of transmitting at least one data frame by at least one relay station after transmitting at least one data frame by a base station. According to one embodiment of the invention stage 810 also includes transmitting by a base station a preamble substantially in parallel to the transmitting of multiple different preambles. Conveniently, the transmitting of at least one data frame by a base station follows the transmitting of the multiple different preambles. Conveniently, the transmitting includes transmitting WiMax compliant transmissions.

Variations, modifications, and other implementations of what is described herein will occur to those of ordinary skill in the art without departing from the spirit and the scope of the invention as claimed. Accordingly, the invention is to be defined not by the preceding illustrative description but instead by the spirit and scope of the following claims.

What is claimed is:

1. A method, comprising: determining a wireless broadband terrestrial transmission scheme by a base station; transmitting, in response to the wireless broadband terrestrial transmission scheme, a first preamble and a first data frame, by a first set of relay stations, towards multiple subscriber devices, substantially simultaneously; and transmitting, in response to the wireless broadband terrestrial transmission scheme, a second preamble and a second data frame by another relay station towards other subscriber devices; wherein a coverage area of the other relay station does not substantially overlap a coverage area of any of the first set of relay stations.

2. The method according to claim 1 wherein a coverage area of a first relay station of the first set of relay stations overlaps a coverage area of a second relay station of the first set of relay stations.

3. The method according to claim 1 wherein the second preamble differs from the first preamble.

4. The method according to claim 1 further comprising dynamically updating the wireless broadband transmission scheme.

5. The method according to claim 1 further updating the wireless broadband terrestrial transmission scheme in response to a state of relay stations and potential relay stations.

6. The method according to claim 1 wherein the determining is responsive to at least one characteristic of terrestrial links established between the base station and multiple relay stations.

7. The method according to claim 1 wherein the transmitting comprises transmitting WiMax compliant transmissions.

8. A method, comprising: transmitting over wireless broadband terrestrial links, by multiple relay stations that are characterized by substantially non-overlapping coverage areas, multiple different preambles substantially simultaneously; and transmitting at least one data frame by at least one relay station after transmitting at least one data frame by a base station.

9. The method according to claim 7 further comprising transmitting by a base station a preamble substantially in parallel to the transmitting of multiple different preambles.

10. The method according to claim 1 wherein the transmitting of at least one data frame by a base station follows the transmitting of the multiple different preambles.

11. The method according to claim 8 wherein the transmitting comprises transmitting WiMax compliant transmissions.

12. A system, comprising: a base station adapted to determine a wireless broadband terrestrial transmission scheme; multiple relay stations adapted to transmit, in response to the wireless broadband terrestrial transmission scheme, a first preamble and a first data frame, towards multiple subscriber devices, substantially simultaneously; and another relay station adapted to transmit, in response to the wireless broadband terrestrial transmission scheme, a second preamble and a second data frame towards other subscriber devices; wherein a coverage area of the other relay station does not substantially overlap a coverage area of any of the first set of relay stations.

13. The system according to claim 12 wherein a coverage area of a first relay station of the first set of relay stations overlaps a coverage area of a second relay station of the first set of relay stations.

14. The system according to claim 12 wherein the second preamble differs from the first preamble.

15. The system according to claim 12 wherein the base station is adapted to dynamically update the wireless broadband transmission scheme.

16. The system according to claim 12 wherein the base station is adapted to update the broadband terrestrial transmission scheme in response to a state of relay stations and potential relay stations.

17. The system according to claim 12 wherein the base station is adapted to determine the wireless broadband transmission scheme in response to at least one characteristic of terrestrial links established between the base station and multiple relay stations.

18. The system according to claim 12 wherein the base station is adapted to transmit WiMax compliant transmissions.

19. A system, comprising: multiple relay stations having substantially non-overlapping coverage areas, that are adapted to transmit over wireless broadband terrestrial links, multiple different preambles substantially simultaneously; and at least one other relay station adapted to transmit at least one data frame after a base station transmits at least one data frame.

20. The system according to claim 19 wherein the base station is adapted to transmit a preamble substantially in parallel to the transmitting of multiple different preambles.

21. The system according to claim 19 wherein the base station is adapted to transmit at least one data frame after the transmission of the multiple different preambles.

22. The system according to claim 19 wherein the base station is adapted to transmit WiMax compliant transmissions.

23. A system comprising: a base station and multiple subscriber stations, wherein the base station controls traffic between the base station and the subscriber stations and wherein at least one subscriber station is adapted to operate as a relay station.

24. The system according to claim 23 wherein the base station is adapted to maximize traffic within the system while maintaining a required quality of service level.

25. The system according to claim 23 wherein transmission characteristics between a base station and a relay station differ from the transmission characteristics between the relay station and a subscriber station.
